(19) United States
(12) Patent Application Publication
(10) Pub. No.: US 2011/0005169 A1
(43) Pub. Date: Jan. 13, 2011

(54) CUTTING DISC, CUTTING DEVICE, AND METHOD FOR SEPARATING PACKAGE UNITS

(75) Inventor: Tommy Ober, Rosenheim (DE)

Correspondence Address: Davidson, Davidson & Kappel, LLC, 485 7th Avenue, 14th Floor, New York, NY, 10018, US

(73) Assignee: Krones AG, Neutraubling (DE)

(21) Appl. No.: 12/831,020

(22) Filed: Jul. 6, 2010

(30) Foreign Application Priority Data
Jul. 7, 2009 (DE) DE102009026 113.3

(51) Int. Cl. B65B 61/08; B26D 1/14; B26D 1/29

(52) U.S. Cl. 53/396; 83/331; 83/664

(57) ABSTRACT

A cutting disc for separating containers (30) in a container-packaging-assembly (44) into defined container groups (31), the cutting disc (24) including two individual discs (22a, 22b). The individual discs (22a, 22b) each include at least one separator, and the rotational speeds of the individual discs (22a, 22b) are individually adjustable and preferably controllable separately of each other. Likewise, a cutting device (20) is disclosed that is employed within a packaging device (10) for containers (30). The described method makes it possible to separate an assembly (44) made from a continuous packaging (40) and a multitude of containers (30) connected with said packaging (40) into predefined container groups (31).

This claims the benefit of German Patent Application DE 10 2009 026 113.3, filed Jul. 7, 2009 and hereby incorporated by reference herein.

The present invention relates to a cutting disc and a cutting device as well as a method for separating package units. The package units are produced by cutting apart containers that are held together by means of foil.

### BACKGROUND

Preceding packaging machines downstream, there is often a separate machine, which is utilized for pulling a continuous plastic foil, adjusted to the respective containers, over the container stream, and subsequently arranging this assembly according to the requested format. This is accomplished by cutting the plastic foil at the intended connecting strips or points. The packages thus formed are then supplied into another packing machine, where these so-called Hi-Cone packages are further assembled and provided with an outer packaging (for example, a pad in the form of a tray or an outer packaging, also called wraparound).

Methods for applying the foil and thus holding together containers of a container stream are known to the expert from prior art.

The packages are cut, for example, by means of laterally rotating cutter rollers. As the cutter rollers would otherwise impede each other, this is only possible for a maximum of two parallel lanes. In order to avoid this difficulty and thus also enable packaging of a multilane container stream, this technology can be combined with a disc arranged at a 45° angle to the transportation direction, whereby the said disc comprises blades attached to it. In particular, devices are known that use one disc each per inner lane, while the two outer lanes are cut with the (also known) rotating cutter rollers.

A further known method for cutting in any number of lanes utilizes blades that push through the packages transversely to the transportation direction and in this way cut all connecting strips or points in the foil.

All the said methods for cutting depend on precise spacing; i.e. altering the container shape or measurements also necessitates the exchange of change-over parts and adjusting them to the bodies to be packaged. This process often involves a considerable effort.

European Patent EP 456 357 B1 describes a device for connecting a multitude of containers (articles), whereby a plastic clip is first applied over the containers, said clip subsequently being cut by separating means.

European Patent EP 572 160 B1 describes a method for producing packages from a plurality of containers. The carrier applied consists of a carrier stock produced from a single sheet of resilient polymeric material, whereby the carrier stock is transversely severable into single carriers.

U.S. Pat. No. 3,032,943 A also describes the application of a plastic clip that is subsequently cut as appropriate.

U.S. Pat. No. 3,991,640 A shows the application of a plastic clip over a plurality of containers, with said plastic clip being supplied as continuous strip that is subsequently cut by means of star wheels with blades and a further cutting mechanism in the form of an individual disc with blades.

U.S. Pat. No. 5,054,257 A discloses a device that connects a multitude of can-type containers to each other with a continuous foil strip and separates them by means of a cutting device into units of a predetermined length. The cutting device works with an exchangeable blade.

U.S. Pat. No. 5,542,231 A describes a similar apparatus, whereby the said apparatus comprises a so-called means for striking, which breaks the carrier stock at the frangible junctions between the handle portion of a first carrier and the handle portion of a second carrier. The said means for striking comprises a polygonal wheel with three arms extending outward and shaped as thin, dull blades. U.S. Pat. Nos. 3,032,943, 3,991,640, 5,054,257 and 5,542,231 A are hereby incorporated by reference herein.

European Patent EP 1 495 969 B1 describes a packing machine for unitizing a plurality of containers using a flexible carrier material. The said flexible carrier stock is divided into appropriate packages by means of a cutoff wheel. The cutoff wheel comprises a plurality of blades positioned around its perimeter at appropriate increments, based upon a desired size of the package. If, for instance, six-packs are desired, the blades will be positioned in between every three container pockets.

### SUMMARY OF THE INVENTION

One task of the present invention is to specify a compact cutting disc with which assemblies made from continuous packaging means and from containers of different sizes and/or shapes can be separated.

Another alternate or additional task of the present invention is to specify a cutting device with which assemblies made from continuous packaging means and from containers of different sizes and/or shapes can be separated without converting the cutting device.

A further alternate or additional task of the present invention is to specify a method for separating containers held together by means of a continuous packaging material into package units. Said separating into packaging units is to be performed quickly, simply, and without any conversion effort for containers of different sizes and/or shapes.

It is a further alternate or additional object of the present invention to provide a cutting disc, and in particular a cutting disc for separating containers into predefined container groups, whereby the containers are connected with each other by packaging, i.e. packaging means.

The containers involved are for instance bottles made of plastic or glass, cans, or the like. In their upper area the containers preferably comprise a shoulder or a similar widening, resulting in an at least slightly enlarged cross-section in the said area as compared to the container top.

The packaging means involved is preferably a foil with pre-punched openings, which are fitted over the containers. The foil is resilient in nature, so that the openings are slightly stretched when fitted over the container, and afterward fit so closely against the containers as to prevent the foil from slipping. Preferably, the packaging means is secured against sliding off the top by the above-described widening. The packaging means can in particular be a continuous foil.

A cutting disc according to the invention comprises two individual discs, with said discs being arranged on a common axis. Said individual discs comprise at least one separating means each. The separating means involved can, for instance, be a sharp blade for cutting the packaging means. Furthermore, said separating means could, however, also be a largely dull means, in particular if the packaging means is previously perforated so that it can be easily separated at the appropriate points.

According to the invention, the rotational speeds of the individual discs can be adjusted individually and they can preferably be controlled separately and independently of each other. According to a preferred embodiment, the two individual discs are operated at different speeds, so that the separating means of the first individual disc move in relation to the separating means of the second individual disc.

Furthermore, the individual discs can each be operated at a constant speed, or else also at a non-constant, time-variant speed. By modifying the control of the two individual discs composing the cutting disc, it is thus possible to easily adjust said cutting disc to differently shaped packages, or to alternating package sizes and/or to varying speeds of the conveyor belt, which supplies the containers to the cutting disc.

By appropriately controlling the speed of the individual discs it becomes possible, for instance, to separate containers alternately after each two, or three, etc. containers, thus producing different package sizes.

According to a preferred embodiment, each of the two individual discs of a cutting disc comprises at least one angular recess on which a separating means is deposited. The said separating means is thereby deposited in such a way as to form an angle between the cutting blade, or the like, and a plane defined by the respective individual disc.

The two individual discs, in turn, are assembled to form the cutting disc in such a way that the angle between the at least one separating means of the first individual disc and the plane of the cutting disc equates to the negative value of the angle between the at least one separating means of the second individual disc and the cutting disc. The angle between the at least one separating means of the first individual disc and the plane of the cutting disc preferably amounts to 45° and the angle between the at least one separating means of the second individual disc and the plane of the cutting disc to −45°.

The invention furthermore relates to a cutting device to be employed within a packaging device for containers.

In such a packaging device, the containers are guided in lanes by means, for instance, of lane separators. The packaging means, for instance a continuous plastic foil, is applied onto the containers employing an application device. Said task is performed employing, for instance, a common method whereby the packaging means is withdrawn from a stock and guided over an application roller which incorporates the known technology necessary for fitting the packaging means over the containers.

The containers assembled by the packaging means subsequently have to be separated into the appropriate, desired container groups.

In particular, the cutting device serves for separating a multitude of containers as described above into container groups, in each of which at least two containers are packaged together, employing a packaging means. Such a cutting device comprises at least one cutting disc with at least two separating means.

According to a preferred embodiment, a cutting disc comprising two individual discs according to the above description is employed. A certain number of blades or other devices for separating the packaging means are attached to these discs at an angle of 45° to the disc plane (in the example shown in the figures there are four separating means per individual disc, i.e. a total of eight separating means per cutting disc). The tilt position of the separating means in relation to the disc plane reduces the dipping angle between the cutting edge of the separating means and the packaging means so that the separating means can be inserted deeper into the spaces between the containers without colliding with said containers.

According to a preferred embodiment, the separating means of the first individual disc are arranged at an angle complementary to that of the separating means of the second individual disc.

According to a preferred embodiment, the separating means of the two individual discs are arranged in such a way that they do not touch each other in the instance of being guided one above the other with the individual discs operated at different speeds. That is to say that the separating means are arranged so that it is possible for the individual discs to counter-rotate free from interference with relation to one another.

According to a preferred embodiment, the cutting device comprises cutting discs in the same number as the number of parallel container rows, which are supplied in the container stream to be processed.

According to a further preferred embodiment, the at least one cutting disc is arranged in the packaging device at an angle to the transportation direction of the container stream supplied. The said angle is preferably 45°.

The above described angle of 45° between separating means and disc plane together with the 45° angle between disc plane and transportation direction of the containers add up to a pressure angle of 90° at which the separating means is inserted into and separates the packaging means which is to be severed. In principle, other angles between separating means and disc plane or between cutting disc and transportation direction of the containers are also possible, as long as the angle of tilt position of the cutting disc and the angle of tilt position of the separating means (for example blade) add up to 90°.

The rotation of the cutting discs results in the separating means dipping into the spaces between the containers, with said containers being connected by the packaging means, and said separating means thus cutting said packaging means at the intended connecting strips or points. In particular, at the precise moment of the cutting process the separating means are at an angle of 90° related to the transportation direction of the containers, or more specifically, perpendicular to the packaging means to be severed. In the severing process, the two individual discs composing the cutting disc alternate with being inserted into the packaging means.

Furthermore, it is possible to combine the cutting device with a fixed separating means, for instance a fixed blade, where said means is preferably arranged downstream and perpendicular to the supplied container stream, thus allowing the production of all common or desired package formations.

The two individual discs composing the cutting disc are each coupled to a drive unit, for instance a servomotor or the like, and said discs can be controlled independently of each other. The fact that the speed differences of the individual discs can thus be adjusted in relation to each other allows the movements of the separating means dipping into and emerging out of the area of the spaces between the containers to be performed optimally in relation to container speed. With regard to the measurements of the containers to be processed, to desired groupings of the containers, etc., this embodiment provides a very high degree of flexibility.

Furthermore, a method is herewith described, with which it is possible to separate an assembly made from a continuous packaging means and containers or to shape said assembly as desired.

In particular, such a method for separating containers that are held together in package units by a packaging means comprises a number of steps, described as follows.

First, the containers to be packaged are supplied in a continuous container stream of at least one row. The containers are subsequently packaged together with the aid of a packaging means. For instance, an appropriate plastic foil with pre-punched openings, as already described above, is fitted over the containers. Afterward, the packaging means is severed at predefined points by means of a cutting disc according to the invention and as described above. In said cutting disc, the speeds of the first and the second individual discs are controlled by at least one controlling means each and separately from each other.

According to another embodiment, a further separating means, for instance in the form of a blade, may be provided for. Said blade can be deposited in extension of a lane separator and thus be employed for severing the packaging means between the containers in the direction of transportation.

In this way, the containers are packaged together in the form of package units with a predefined size.

The invention thus describes a cutting disc, a cutting device, and a method, allowing to cut the assembly made from continuous packaging means and containers and, respectively, to shape it according to the requested, common format, for instance as 1×2 containers, 2×2 containers, 2×3 containers, n×m containers, etc. This can be performed regardless of the desired format and, respectively, container measurements. The conversion to a different format or different container measurements is performed by a new instruction from the controlling device, for example by an adjustment of width and/or by converting various parameters in the controlling software of the controlling unit.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows an embodiment of a packaging device for assembling and packaging containers, wherewith the cutting disc according to the invention is employed;

FIG. 2 shows a lateral view of the packaging device according to FIG. 1;

FIGS. 3a, 3b and 3c show an embodiment of a cutting disc (cutting wheel) according to prior art in the form of one individual disc;

FIGS. 4a, 4b and 4c show the cutting disc according to FIGS. 3a to 3c being employed for severing a foil sheet (prior art);

FIG. 5 shows a foreshortened view of one embodiment of the cutting disc according to the invention in the form of a double disc;

FIGS. 6a and 6b show top views of two alternative embodiments of the cutting device according to the invention, as employed in a packaging device according to FIG. 1 and, respectively, FIG. 2;

FIG. 7 shows a detailed, lateral view of one separate double disc of the cutting device according to FIG. 6a or 6b for a single lane and

FIGS. 8a to 8d show detailed lateral views of a number of steps in the cutting process using the cutting device according to FIGS. 6a, 6b, and 7.

### DETAILED DESCRIPTION

The same or equivalent elements of the invention are designated by identical reference characters. Furthermore and for the sake of clarity, only the reference characters relevant for describing the respective figure are provided. It should be understood that the embodiments described are only examples of designing the cutting device, the cutting wheel, or the method according to the invention, and they are not intended to limit the scope of the disclosure.

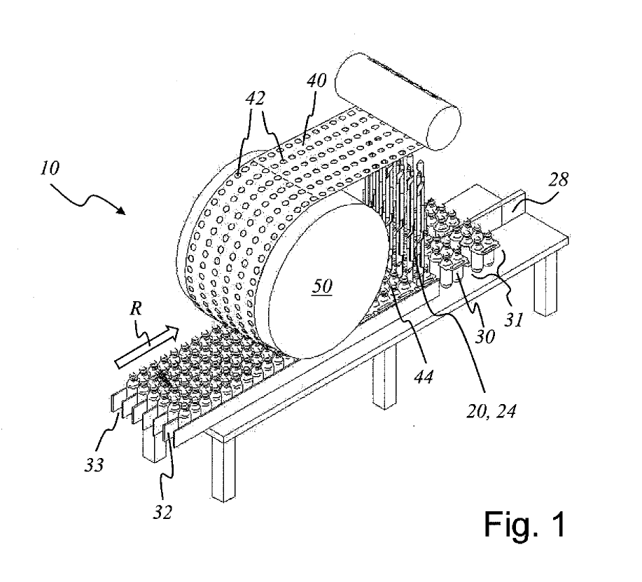

FIG. 1 shows a general view of the modules involved in an embodiment of a packaging device 10. The containers 30 to be packaged are guided into the appropriate lanes 33 with the aid of lane separators 32. This is followed by the application of the plastic foil 40 as a packaging means over the containers 30, employing a common method. The prefabricated foil 40, comprising pre-punched openings 42, is thereby withdrawn from a stock and guided over a roller 50. The roller 50 incorporates the technology necessary for fitting the foil 40 over the containers 30, resulting in a container-foil-assembly 44.

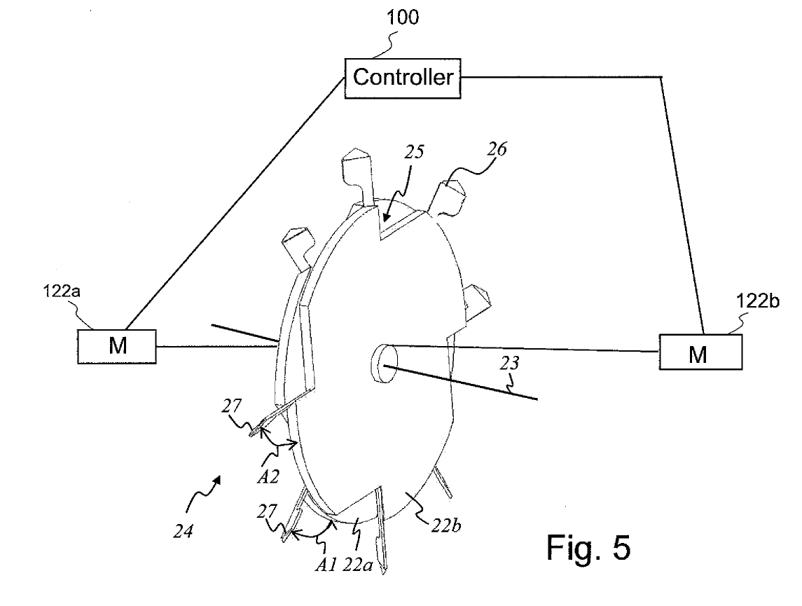

The foil 40 is subsequently cut with the aid of a cutting device 20. The cutting device 20 comprises a plurality of cutting discs 24 deposited next to one another, as described in more detail in FIGS. 5 to 8d. Furthermore, the packaging device 10 comprises an additional cutting device 28 deposited downstream in the direction of transportation R. Said cutting device 28 performs the severing of the foil 40 and the containers 30 along the direction R of transporting the containers 30. A further cutting device 28 may comprise, for instance, a fixed, a laterally slidable, or also a completely removable blade.

Severing the container-foil-assembly 44 with the aid of the cutting device 20, and, as the case may be, in combination with an additional, optional cutting device 28, results in package units 31 of the required size or shape.

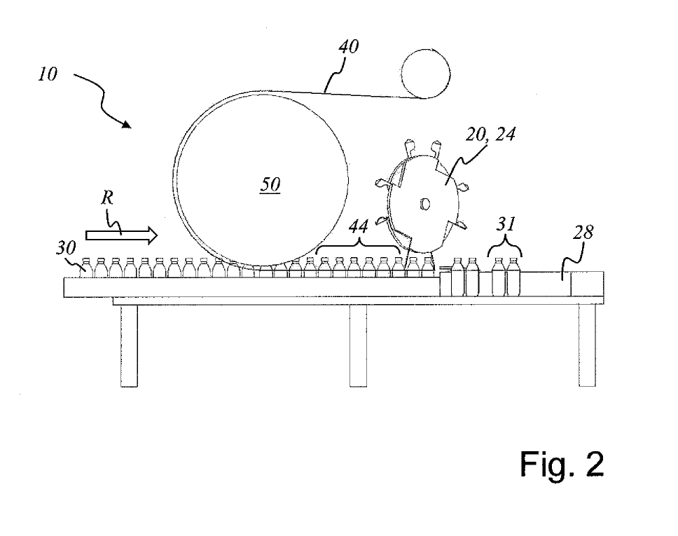

FIG. 2 shows a lateral view of the elements involved and already described in the context of FIG. 1.

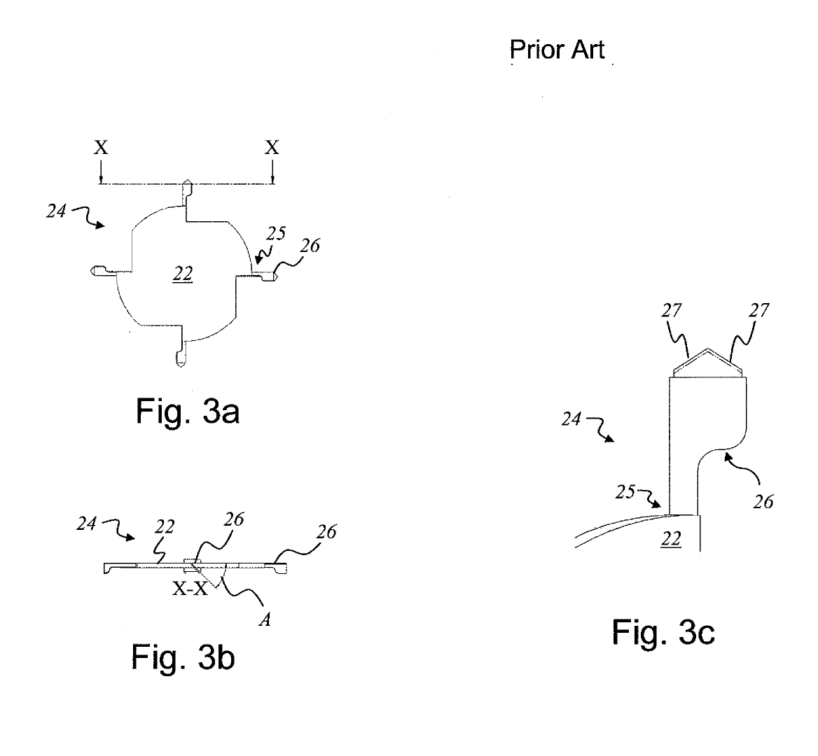

FIG. 3a shows the prior art as known, for instance, from U.S. Pat. No. 3,991,640 A, in a lateral view of a cutting disc 24 in the form of an individual disc 22 with four separating means 26 for cutting foil (the latter not illustrated in FIG. 3a).

The individual disc 22 comprises four angular recesses 25, on each of which a separating means 26, for instance a cutting blade or the like, is deposited.

FIG. 3b shows a further illustration of the individual disc 22, namely of a section along the line X-X of FIG. 3a. As is easily recognizable in this figure, the separating means 26 are arranged at an angle A related to the individual disc 22. This provides for an optimal dipping of the separating means 26 into the packaging material 40 (the latter not illustrated in FIG. 3b) and severing of the same.

FIG. 3c shows an extract of cutting disc 24 according to the FIGS. 3a and 3b, and in particular the separating means 26 in detail. The said separating means comprises, for instance, two cutting edges 27 for cutting the packaging means.

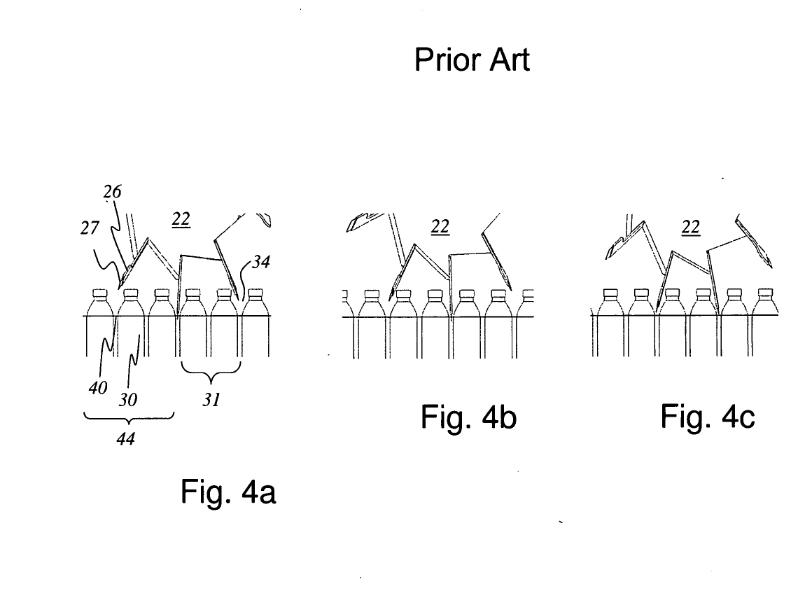

FIGS. 4a to 4c show the process of cutting a container-foil-assembly 44 by means of an individual disc 22 according to the FIGS. 3a to 3c. The separating means 26 with their cutting edges 27 are attached to the individual disc 22 at defined spacings. Said spacings result in the foil 40 always being cut at predefined intervals. If it is required to package containers 30 of a different shape and/or of a different size, or if different package sizes or different package units 31 are required, for instance packages of threes, etc., instead of packages of twos 31 as shown here, a different individual disc 22 of a different diameter and/or with a different number of separating means 26 will need to be selected. This involves the exchange of individual discs 22 on the machine. Said exchange can be performed manually or electronically controlled via a robot, causing an extended standstill of the machine and thus being time-consuming and costly.

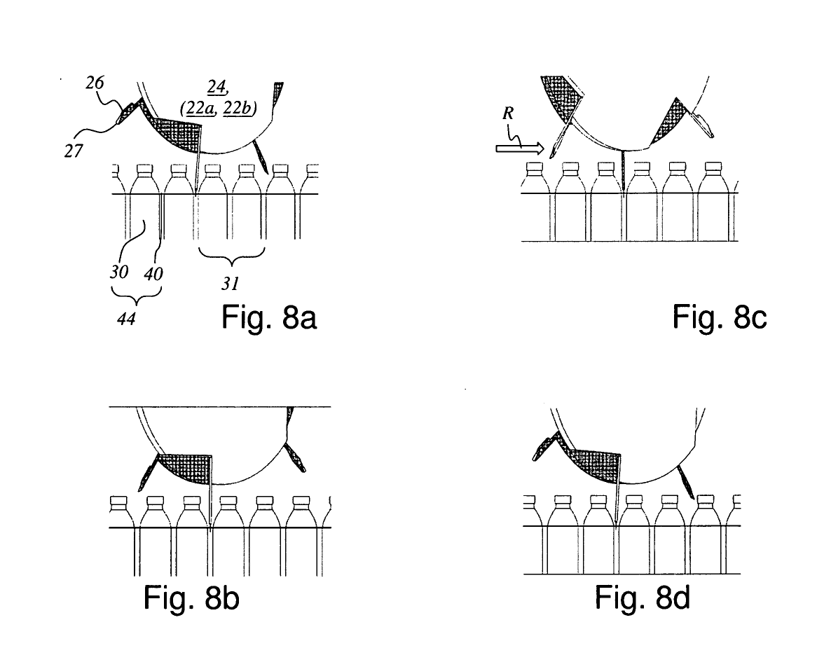

FIG. 5 shows an embodiment of the cutting disc according to the invention in the form of a double disc 24. Here, the cutting disc in the form of an individual disc 22, as known from the prior art and as illustrated in FIGS. 3a to 3c as well as in 4a to 4c, is designed as a double disc 24, whereby each individual disc 22a, 22b can be separately controlled and adjusted with regard to rotational speed and with regard to the ratio between the rotational speeds of the individual discs 22a, 22b. This is described in more detail in FIGS. 8a to 8d.

The two cutting discs 22a, 22b, which are arranged on a common rotational axis 23, are, for instance, each coupled to a servomotor 122a, 122b, respectively, or a similar drive unit, so that the individual discs 22a, 22b can be controlled independently of each other, via for example a controller 100. This makes it possible for the two individual discs 22a, 22b to rotate at different speeds in relation to each other. In this way, the dipping and emerging of the separating means 26 into and, respectively, out of the spaces 34 between the containers 30 can be performed optimally in relation to transportation speed, size, etc., of the containers 30.

If it is thereby required to process containers 30 or packages of a different shape, it will no longer be necessary to exchange the cutting disc 24. Instead, the speeds of the two individual discs 22a, 22b composing the double disc 24 are accordingly readjusted and reset.

In particular, it is possible to operate the two individual discs 22a, 22b independently of each other at a non-constant speed. The velocity curves of the individual discs 22a, 22b are thereby controlled so as to be adjusted optimally to the required container groups 31.

Thereby, the separating means 26 with their cutting edges 27 are deposited on each of the individual discs 22a and 22b in such a way that the cutting edges 27 of each of the individual discs 22a and 22b form an angle A1 and A2, respectively, in relation to the planes of the individual discs 22a and 22b, respectively. The said angles A1, A2 are preferably of the same value and arranged complementary in relation to the disc plane as defined by cutting disc 24.

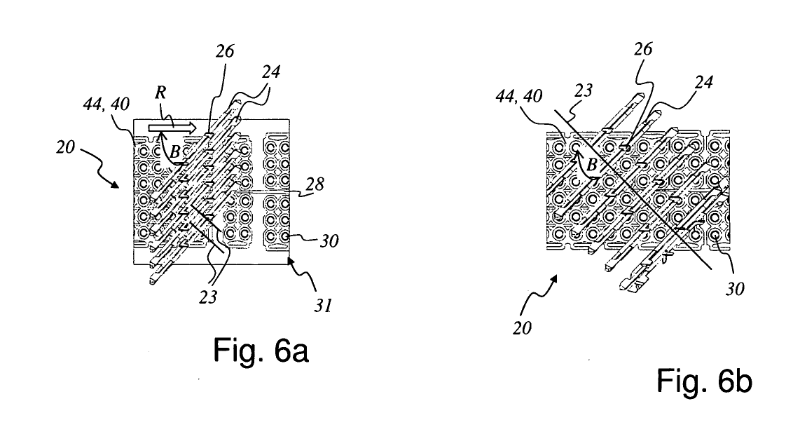

FIGS. 6a and 6b show the basic designs of two alternative embodiments of a cutting device 20 according to the invention. The cutting device 20 in both embodiments comprises a multitude of double discs 24, as already illustrated in FIG. 5. For each container lane 33 involved in the process, one double disc 24 is needed, with each said double disc in turn comprising two rotating individual discs 22a, 22b. By employing two individual discs 22a, 22b per double disc 24, whereby each of the said individual discs 22a, 22b can be controlled and adjusted independently of the other, a very high degree of flexibility is achieved with regard to the measurements of the processed containers 30 and with regard to the required package units 31.

According to a preferred embodiment, the double discs 24 are arranged at an angle B, in particular at an angle of 45°, in relation to the direction R of transporting the containers 30. On the individual discs 22a, 22b composing the double discs 24, a defined number of blades 26 or other means for severing the foil 40 is deposited, preferably at an angle of A1=45° and A2=−45°, respectively, in relation to the corresponding disc plane, as illustrated in detail in FIG. 5. The illustrated embodiment provides for four blades 26 per individual disc 22a, 22b so that a double disc 24 comprises a total of eight blades 26. In these two alternative embodiments, preferably all left-hand individual discs 22a of each double disc 24 are to be operated with a first, common drive, and all right-hand individual discs 22b of each double disc 24 with a second, common drive.

FIG. 6a shows a compact first embodiment of the cutting device 20 according to the invention, with the separate double discs 24 being arranged in such a way that their rotational axes 23 are each parallel to and separate from each other. Each cutting disc 24 is thereby provided with its own drive.

FIG. 6b shows a second embodiment of the cutting device 20 according to the invention, with the separate double discs 24 being arranged on a common rotational axis 23. The resulting structure of the cutting device 20 is thus slightly larger; the coupling of the discs 24, on the other hand however, goes along with constructive advantages.

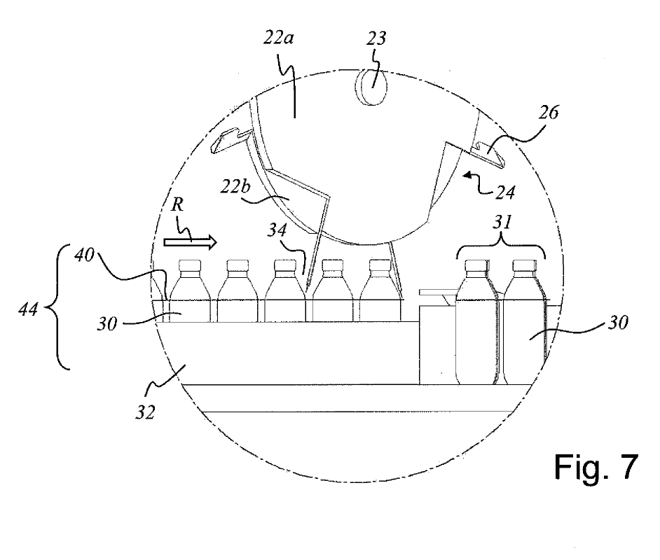

In principle, other angles A1, A2, B are also possible, as long as the angle of the tilt position B of double disc 24 in relation to the transportation direction R of the containers 30 and the angle A1 and A2, respectively, of the separating means 26 in relation to the disc plane add up to an angle of 90°. The tilt position of the double disc 24 in relation to the transportation direction R, and thus in relation to the foil 40, reduces the dipping angle of double disc 24 so that it is possible for the separating means 26 to be inserted deeper into the spaces 34 (see FIGS. 4a, 7) between the containers 30, without that the separating means 26 collide with the containers 30.

The rotation of the cutting discs 22a, 22b results in the separating means 26 to be dipped into the spaces 34 between the containers 30 of the container-foil-assembly 44 and further results in the separating means 26 to cut or sever the foil 40 at the intended connecting strips or points. In combination with a fixed blade 28, it is thus possible to produce all common package formations 31. The conversion to a different container size is thus performed by converting the relevant parameters in the software of the controlling unit and by adjusting the width settings for the cutting discs.

In particular, it is possible to provide for the separating means 26 to be adjustable in relation to the plane of the cutting disc 24. They can then be accordingly adjusted, when the angle of tilt position B of double disc 24 relative to the transportation direction R of the containers 30 is changed. It will preferably be adjusted in such a way that the sum of the absolute values of angles A1 and B, and the sum of the absolute values of angles A2 and B, respectively, always adds up to 90°.

The described cutting device 20 allows for single lane as well as multilane processing. All left-hand cutting discs 22a are coupled to a first servomotor and all right-hand cutting discs 22b to a second servomotor, i.e. it is possible to rotate or operate the left-hand individual discs 22a independently of the right-hand individual discs 22b. Preferably, the two individual discs 22a, 22b are operated at different speeds so that the two individual discs 22a, 22b in a double disc counter-rotate relative to one another. With this possibility of the two individual discs 22a, 22b being operated at different speeds relative to one another, the movement of the separating means 26 respectively dipping into and emerging out of the spaces 34 between the containers 30 can be performed optimally in relation to container 30 speed. This is described in detail in FIGS. 8a to 8d.

In a detailed view, FIG. 7 shows the employment of one separate double disc 24 of a cutting device according to FIG. 6a or 6b for one single lane 33. The foil 40, which is fitted over the assembled containers 30, is severed with the aid of the separating means 26, for instance blades, of the two individual discs 22a, 22b composing double disc 24.

FIGS. 8a to 8d illustrate the exact procedure of the process of cutting a container-foil-assembly 44, employing a cutting disc 24 according to the invention. According to FIGS. 8b, 8c and to the embodiment described here, the respective separating means 26 of the cutting disc 24 dips deepest into the foil 40, when the separating means 26 is perpendicular to the taut foil 40, or more specifically, to the transportation direction R of the containers 30.

In these figures it is recognizable that the two individual discs 22a, 22b composing the cutting disc 24 are always alternately, one after the other, inserted into the foil 40. It is possible to adjust the respective spacings, at which the container-foil-assembly 44 is cut, according to the selected speed of the individual discs 22a, 22b. The cuts can be performed, for instance, after every row of containers 30, after every other row, after every three rows, etc.

This adjustment is performed with the aid of an electronic control. In particular, only software parameters need to be altered without requiring the mechanical exchange of cutting discs 24. It is thus not necessary to provide different change-over parts for varying package units 31. In addition, this process requires no manual exchange of the cutting discs 24 or of their change-over parts, which would otherwise result particularly in an extended standstill of the cutting device 20. Furthermore, this system provides for a high degree of flexibility with regard to the container groups 31.

The invention has been described with reference to preferred embodiments. To the expert it is also conceivable, however, to make changes and modifications without leaving the scope of protection of the appended claims.

### LIST OF REFERENCE CHARACTERS

A, A1, A2 Angle between separating means and disc plane
B Angle between cutting disc and container stream
R Direction of transportation of the containers
10 Packaging device
20 Cutting device
22, 22a, 22b Individual disc
23 Axis of rotation
24 Double disc/cutting disc
25 Angular recess
26 Blade/separating means
27 Cutting edge
28 Additional cutting device
30 Container
31 Container group/package unit
32 Lane separator
33 Lane
34 Space between the containers
40 Plastic foil/packaging means
42 Openings in packaging means
44 Container-packaging means-assembly/container-foil-assembly
50 Roller
100 Controller
122a Servomotor
122b Servomotor

What is claimed is:

1. A cutting disc for separating a multitude of containers into container groups with the containers being connected by packaging, the cutting disc comprising:
a first individual disc; and
a second individual disc on a common rotational axis with the first individual disc, each of the first and second individual discs including at least one separator, rotational speeds of the first and second individual discs each being controllable independently of each other.

2. The cutting disc according to claim 1 wherein each of the first and second individual discs includes at least one angular recess, and with the at least one separator being located on each of said recesses.

3. The cutting disc according to claim 1 wherein the at least one separator of the first individual disc is arranged at a first angle, and the at least one separator of the second individual disc is arranged at a second angle in relation to a plane defined by the first and second discs, the values of the first and second angles being equal.

4. The cutting disc according to claim 3 wherein the value of the first and second angles is 45°.

5. A cutting device for separating a multitude of containers into container groups with the containers being connected by packaging, each container group including at least two connected containers, the cutting device comprising:
at least one cutting disc including at least one separator, the at least one cutting disc including a first individual disc and a second individual disc, the rotational speeds of the first and second individual discs being controllable independently of each other.

6. The cutting device according to claim 5 wherein the individual first and second discs are rotatable at variable speeds.

7. The cutting device according to claim 5 wherein the at least one cutting disc is arranged at an angle in relation to a transportation direction of the containers.

8. The cutting device according to claim 7 wherein the angle is 45°.

9. The cutting device according to claim 5 wherein the at least one separator is arranged on the first individual disc and the second individual disc, respectively, at a first angle and a second angle, respectively, in relation to a plane defined by the at least one double disc, the values of the first and second angles being equal.

10. The cutting device according to claim 9 wherein the value of the first and second angles 45°.

11. The cutting device according to claim 7 wherein the angle between the at least one cutting disc and the transportation direction of the containers, and the angle between one of the separators and the plane of the at least one cutting disc add up to an angle of 90°.

12. A method for separating containers held together by packaging into package units, the package units including at least two containers connected with each other, the method comprising the following steps:
supplying the containers in a continuous container stream of at least one row;
connecting the containers with packaging to form a container-packaging-assembly;
separating the packaging at predefined points in the container-packaging-assembly in such a way that the containers are assembled in package units of a predefined size, the separating being performed by a cutting disc comprising first and second individual discs with at least one separator each, and
at least one controller controlling speeds of each the first and the second individual discs independently.

13. The method according to claim 12 wherein the first and second individual discs are each operated at different speeds.

14. The method according to claim 13 wherein the first and second individual discs are each operated at time-variant speeds.

15. The method according to claim 12 wherein the separators are inserted into the packaging at an angle of 90°, with the separators severing the packaging.
